(19) United States
(12) Patent Application Publication
(10) Pub. No.: US 2010/0223207 A1
(43) Pub. Date: Sep. 2, 2010

(54) Computer Systems and Methods for Generating Home Service Sales

(76) Inventor: Terry J. Nicholson, St. Louis, MO (US)

Correspondence Address: HARNESS, DICKEY, & PIERCE, P.L.C, 7700 Bonhomme, Suite 400, ST. LOUIS, MO, 63105, US

(21) Appl. No.: 12/713,815

(22) Filed: Feb. 26, 2010

Related U.S. Application Data
(60) Provisional application No. 61/156,261, filed on Feb. 27, 2009.
(60) Provisional application No. 61/187,871, filed on Jun. 17, 2009.

(51) Int. Cl. G06Q 90/00

(52) U.S. Cl. 705/500

(57) ABSTRACT

According to one exemplary embodiment, a method of generating home service sales includes identifying a home having a condition in need of service, and sending at least a first notice to the owner of the home, the notice including the address of the home and identifying the condition in need of service. The method may optionally include sending one or more subsequent notices to the homeowner, each notice optionally including the homeowner's address, an illustration of the condition in need of service, and/or the address of a website where the homeowner can obtain information about the condition in need of service. The condition may be a roof condition, an HVAC condition, or any other condition of the home in need of service. A method of generating home service sales may also employ a website and include collecting a user name and password from a remote user, the password corresponding to a condition of the user's home in need of service, and displaying a video to the remote user via the website, the video providing information to the remote user regarding the condition in need of service.

### CROSS-REFERENCE TO RELATED APPLICATIONS

This application claims the benefit of U.S. Provisional Application No. 61/156,261, filed on Feb. 27, 2009 and U.S. Provisional Application No. 61/187,871, filed on Jun. 17, 2009. The entire disclosures of the above applications are incorporated herein by reference.

### FIELD

The present disclosure relates to computer systems and methods for generating home service sales, including sales of roofing services, HVAC services, and the like.

### BACKGROUND

This section provides background information related to the present disclosure which is not necessarily prior art.

As recognized by the present inventor, in the residential roofing industry, roofing contractors survive by replacing roofs that are old or faulty in some way. However, for many small roofing contractors, almost the only way to receive calls from homeowners is to wait until a roof starts leaking. The majority of homeowners do not recognize problems with their roof until water leaks into their home, which is often weeks or months after the actual problem has occurred. These eventual leaks can result in severe damage and unexpected expenses for homeowners, and many of these expenses could have been prevented with timely identification and repair of the problems.

Some roofing contractors try to market their services to homeowners in their community via direct mailings, door hangers, flyers, etc. As noted above, however, even if such marketing is successful with some homeowners, the homeowners are still usually unaware of problems with their roof until they discover a leak. Further, many roofing contractors cannot spend enough on marketing to remain memorable, so that homeowners call that particular contractor when a leak is discovered. Instead, the homeowner will likely call the roofer in town with the biggest advertising budget, making it difficult for small contractors to compete.

The same can be said for a wide variety of other contractors that provide property-related services to homeowners and business owners, including HVAC, landscaping, paving, hardscape, siding, foundation, window, window treatment, lighting, home security (including fire and/or burglary), masonry, structural, door, excavating, fencing, glass, irrigation, paint, pest and swimming pool contractors.

### SUMMARY

This section provides a general summary of the disclosure, and is not a comprehensive disclosure of its full scope or all of its features.

According to one aspect of the present disclosure, a method of generating home service sales includes identifying a home having a condition in need of service, and sending at least a first notice to the owner of the home, the notice including the address of the home.

According to another aspect of the present disclosure, a method of generating home service sales includes identifying a home having a condition in need of service, and sending at least a first notice to the owner of the home, the notice identifying the particular condition in need of service.

According to yet another aspect of the present disclosure, a method of generating home service sales includes identifying a home having a condition in need of service, and sending at least a first notice to the owner of the home, the notice including the address of the home and identifying the condition in need of service.

According to still another aspect of the present disclosure, a method of generating home service sales using a website includes collecting a user name and password from a remote user, the password corresponding to a condition of the user's home in need of service, and displaying a video to the remote user via the website, the video providing information to the remote user regarding the condition in need of service.

Further areas of applicability will become apparent from the description provided herein. The description and specific examples in this summary are intended for purposes of illustration only and are not intended to limit the scope of the present disclosure.

### DETAILED DESCRIPTION

Attached as an appendix to one of the above-identified provisional applications are descriptions of several exemplary embodiments of this disclosure related to roofing services. These embodiments provide contractors with means to identify homes that are in need of a roof repair or an entirely new roof and alert the homeowners to their home's specific problem.

This targeted approach allows the contractor to save money by marketing only to those homes with a roofing problem, and it provides the homeowner with specific information about their home. That specific information, given in advance of a leak, increases the calls for repairs for contractors and gives homeowners a way to protect their home and head off major damage and expenses in advance.

The various roofing embodiments optionally combine targeted marketing pieces with interactive web videos regarding specific roofing problems. Some embodiments highlight the following common roofing problems: algae; missing shingles; missing tiles; curling shingles; cracked tiles; buckled shingles; fried shingles; damaged flashing; ice dams; split shakes; dark patches; granule loss; and inadequate ventilation.

After a roofing contractor visually identifies one of these problems on a home, they note the homeowner's address. Then, using the marketing pieces, they can optionally insert that homeowner's address into the headline of the actual marketing piece. This step makes the piece stand out to the homeowner when they receive it in the mail and increases the chances of it being read. (For example: Your Roof at 2631 Camino Drive is Beginning to Show Nasty, Ugly Algae Streaks!).

The marketing pieces may include door hangers, letters, postcards, emails and/or interactive web videos highlighting the various roofing problems.

In some embodiments, the marketing piece that a homeowner receives directs them to the contractor's website. Once there, they are directed to enter their username and password to view a specific video about their home's roofing problem. (The username is the homeowner's address and the password is a keyword supplied by the contractor.) After logging in, the specific video loads automatically. This gives the homeowner specific information about their roofing problem from a trusted source without the need to even call the company or talk to a salesperson. After viewing the video, the homeowner is invited to contact the contractor for help with their roofing problem. Overall, this system provides an interactive web experience that provides the homeowner with information about their home and it provides the contractor with a way to get important information to a homeowner that will ideally lead to a repair or roof replacement call.

Additionally, in some embodiments, the contractor can receive notifications (e.g. via email) when a homeowner has watched the video so the contractor can perform real time tracking of their marketing results. This is advantageous as compared to paper-based marketing where the impact of a marketing piece is often difficult to measure.

For the homeowner, the disclosed methods and systems provide advanced warning on roofing problems before those problems lead to a catastrophic event. For the roofing contractor, the disclosed methods and systems can significantly reduce marketing expenses while significantly increasing the return on investment they receive from their marketing dollars.

It should be understood that various changes can be made to any one or all of these roofing services embodiments without departing from the scope of this disclosure.

Attached as an appendix to another one of the above-identified provisional applications are descriptions of several exemplary embodiments of this disclosure related to heating, ventilation, and/or air conditioning (“HVAC”) services. These embodiments provide contractors with means to identify homes that are in need of an HVAC repair or an entirely new HVAC system, and alert the homeowners to their home's specific problem.

This targeted approach allows the contractor to save money by marketing only to those homes with an HVAC problem, and it provides the homeowner with specific information about their home. That specific information, given in advance of a problem, increases the calls for repairs for contractors and gives homeowners a way to protect their home and head off major damage and expenses in advance.

The various HVAC embodiments optionally combine targeted marketing pieces with interactive web videos regarding specific HVAC problems. Some embodiments highlight the following common HVAC problems: old system; dirty/rusty system; damaged coils; damaged or missing refrigeration line set; system out of level; poor or improper slab; overgrown vegetation; inadequate spacing from home; improper electrical disconnect; holes in package system ductwork; and iced-over heat pump.

After an HVAC contractor visually identifies one of these problems on a home, they note the homeowner's address. Then, using the marketing pieces, they can optionally insert that homeowner's address into the headline of the actual marketing piece. This step makes the piece stand out to the homeowner when they receive it in the mail and increases the chances of it being read. (For example: Your HVAC System at 2631 Camino Drive Looks Like It's Ready to Retire!).

The marketing pieces may include door hangers, letters, postcards, emails and/or interactive web videos highlighting the various HVAC problems.

In some embodiments, the marketing piece that a homeowner receives directs them to the contractor's website. Once there, they are directed to enter their username and password to view a specific video about their home's HVAC problem. (The username can be the homeowner's address and the password may be a keyword supplied by the contractor.) After logging in, the specific video loads automatically. This gives the homeowner specific information about their HVAC problem from a trusted source without the need to even call the company or talk to a salesperson. After viewing the video, the homeowner is invited to contact the contractor for help with their HVAC problem. Overall, this system provides an interactive web experience that provides the homeowner with information about their home and it provides the contractor with a way to get important information to a homeowner that will ideally lead to an HVAC repair or an HVAC system replacement call.

Additionally, in some embodiments, the contractor can receive notifications (e.g. via email) when a homeowner has watched the video so the contractor can perform real time tracking of their marketing results. This is advantageous as compared to paper-based marketing where the impact of a marketing piece is often difficult to measure.

For the homeowner, the disclosed methods and systems provide advanced warning of HVAC problems before those problems lead to a catastrophic event. For the HVAC contractor, the disclosed methods and systems can significantly reduce marketing expenses while significantly increasing the return on investment they receive from their marketing dollars.

It should be understood that various changes can be made to any one or all of these HVAC services embodiments without departing from the scope of this disclosure.

Further, it should be understood that the teachings of this disclosure can be applied to virtually any service relating to a homeowner's (or business owner's) property including, without limitation, landscaping, paving, hardscape, siding, foundation, window, window treatment, lighting, home security (including fire and/or burglary), masonry, structural, door, excavating, fencing, glass, irrigation, paint, pest and swimming pool services.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A method of generating home service sales, the method comprising:
identifying a home having a condition in need of service; and
sending at least a first notice to the owner of said home, the notice including the address of said home and identifying the condition in need of service.

2. The method of claim 1 further comprising sending a second notice to the owner of said home after sending the first notice, the second notice being designated a “second notice.”

3. The method of claim 2 further comprising sending a subsequent notice to the owner of said home after sending the second notice, the subsequent notice being designated a “final notice.”

4. The method of claim 3 wherein the first notice is a letter, and wherein the second and subsequent notices are postcards.

5. The method of claim 3 wherein the subsequent notice illustrates said condition in need of service.

6. The method of claim 1 further comprising sending a subsequent notice to the owner of said home after sending the second notice, the subsequent notice indicating the condition is worsening.

7. The method of claim 1 further comprising sending a second notice to the owner of said home after sending the first notice, the second notice illustrating said condition in need of service.

8. The method of claim 1 further comprising determining whether said owner requests service of said condition within a predetermined time after sending the first notice and, if not, sending a second notice to the owner, the second notice identifying the condition in need of service.

9. The method of claim 8 further comprising determining whether said owner requests service of said condition within a predetermined time after sending the second notice and, if not, sending a subsequent notice to the owner, the subsequent notice identifying the condition in need of service.

10. The method of claim 1 wherein the home is for sale, and wherein the first notice indicates said condition may affect a selling price of the home.

11. The method of claim 3 wherein at least one of said notices includes a photograph of said home illustrating said condition.

12. The method of claim 1 further comprising completing a form for said home.

13. The method of claim 12 wherein completing a form includes completing a separate form for each home identified as having a condition in need of service.

14. The method of claim 12 wherein the form includes a predetermined list of potential conditions and wherein completing the form includes checking at least one of the potential conditions.

15. The method of claim 12 further comprising entering data from the completed form into a database.

16. The method of claim 1 wherein the first notice is one of a letter, postcard, email and door hanger.

17. The method of claim 1 wherein the first notice offers a multi-point inspection of said home for a predetermined price.

18. The method of claim 1 further comprising selecting the first notice from a predetermined group of notices, each notice addressing a different service potentially needed by a homeowner.

19. The method of claim 18 further comprising adding said address of said home to the selected notice.

20. The method of claim 1 wherein identifying said home includes inspecting homes in a neighborhood while servicing another home in said neighborhood.

21-61. (canceled)
